(19) United States
(12) Patent Application Publication
(10) Pub. No.: US 2024/0392096 A1
(43) Pub. Date: Nov. 28, 2024

(54) NOVEL FEED FOR WASTE PLASTIC COPROCESSING IN A REFINERY

(71) Applicant: Chevron U.S.A. Inc., San Ramon, CA (US)

(72) Inventors: Joel Edward SCHMIDT, San Ramon, CA (US); Richard L. GROVE, San Ramon, CA (US); Robert MONTGOMERY, San Ramon, CA (US); Tengfei LIU, San Ramon, CA (US); Hye-Kyung Cho TIMKEN, Albany, CA (US)

(73) Assignee: Chevron U.S.A. Inc., San Ramon, CA (US)

(21) Appl. No.: 18/671,065

(22) Filed: May 22, 2024

Related U.S. Application Data
(60) Provisional application No. 63/503,994, filed on May 24, 2023.

(51) Int. Cl. C08J 11/18

(52) U.S. Cl. CPC C08J 11/18; C08J 2323/06; C08J 2323/12

(57) ABSTRACT

Provided is a stable blend of a petroleum atmospheric tower bottoms (ATBs) feedstock and 1-20 wt. % of plastic, based on the weight of the blend, with the plastic comprising polyethylene and/or polypropylene, and the plastic in the blend comprising finely dispersed microcrystalline particles having an average particle size of 10 micron to less than 100 microns. A process for preparing a stable blend of plastic and petroleum is provided, comprising mixing together a petroleum feed and a plastic comprising polyethylene and/or polypropylene and heating the mixture above the melting point of the plastic, but less than 500° F. Then cooling the plastic melt and petroleum feedstock liquid blend with mixing to a temperature below the melting point of the plastic.

### CROSS-REFERENCE TO RELATED APPLICATIONS

The present application claims priority to U.S. provisional patent application 63/503,994 filed on May 24, 2023, the disclosure of which is hereby incorporated by reference in its entirety.

### BACKGROUND

The world has seen extremely rapid growth of plastics production. According to PlasticEurope Market Research Group, the world's plastics production was 335 million tons in 2016, 348 million tons in 2017 and 359 million tons in 2018. According to Mckinsey & Company, the global plastics-waste volume was estimated about 260 million tons per year in 2016 and projected to be 460 million tons per year by 2030 if the current trajectory continues.

Single use plastic waste has become an increasingly important environmental issue. At the moment, there appear to be few options for recycling polyethylene and polypropylene waste plastics to value-added chemicals and fuel products. Currently, only a small amount of polyethylene/polypropylene is recycled via chemical recycling, where recycled and cleaned plastic pellets are pyrolyzed in a pyrolysis unit to make fuels (naphtha, diesel), steam cracker feed or slack wax. The majority, greater than 80%, is incinerated, land filled or discarded.

The current method of chemical recycling via pyrolysis cannot make a big impact for the plastics industry. The current pyrolysis operation produces poor quality fuel components (naphtha and diesel range products), but the quantity is small enough that these products can be blended into fuel supplies. However, this simple blending cannot continue if we have to recycle very large volumes of waste polyethylene and polypropylene to address the environmental issues. The products as produced from the pyrolysis unit have too poor quality to be blended in large amounts (for example 5-20 volume % blending) in transportation fuels.

Processes are known which convert waste plastic into hydrocarbon lubricants. For example, U.S. Pat. No. 3,845,157 discloses cracking of waste or virgin polyolefins to form gaseous products such as ethylene/olefin copolymers which are further processed to produce synthetic hydrocarbon lubricants. U.S. Pat. No. 4,642,401 discloses the production of liquid hydrocarbons by heating pulverized polyolefin waste at temperatures of 150-500° C. and pressures of 20-300 bars. U.S. Pat. No. 5,849,964 discloses a process in which waste plastic materials are depolymerized into a volatile phase and a liquid phase. The volatile phase is separated into a gaseous phase and a condensate. The liquid phase, the condensate and the gaseous phase are refined into liquid fuel components using standard refining techniques. U.S. Pat. No. 6,143,940 discloses a procedure for converting waste plastics into heavy wax compositions. U.S. Pat. No. 6,150,577 discloses a process of converting waste plastics into lubricating oils. EP0620264 discloses a process for producing lubricating oils from waste or virgin polyolefins by thermally cracking the waste in a fluidized bed to form a waxy product, optionally using a hydrotreatment, then catalytically isomerizing and fractionating to recover a lubricating oil.

U.S. Pub. No. 2021/0130699 discloses processes and systems for making recycle content hydrocarbons from recycled waste material. The recycle waste material is pyrolyzed to form a pyrolysis oil composition, at least a portion of which may then be cracked to form a recycle olefin composition.

Other documents which relate to processes for converting waste plastic into lubricating oils include U.S. Pat. Nos. 6,288,296; 6,774,272; 6,822,126; 7,834,226; 8,088,961; 8,404,912 and 8,696,994; and U.S. Patent Application Publication Nos. 2019/0161683; 2016/0362609; and 2016/0264885. The foregoing patent documents are incorporated herein by reference in their entirety.

Globally, recycling or upcycling of plastic waste has gained great interest to save resources and the environment. Mechanical recycling of plastic waste is rather limited due to different types, properties, additives, and contaminants in the collected plastics. Usually, the recycled plastics are of degraded quality. Chemical recycling to the starting material or value-added chemicals has emerged as a more desirous route.

However, in order to achieve chemical recycling of single use plastics in an industrially significant quantity to reduce its environmental impact, more robust processes are needed. Such a process may require unique handing and manipulation of the waste plastic. The use of opportunistic feeds may also enhance efficiency of an overall process thereby providing positive economics.

### SUMMARY

In one embodiment, provided is a novel composition of a stable blend of a waste plastic and a petroleum based feedstock for direct conversion of waste plastic in a refinery process unit.

Provided in one embodiment is a process for preparing a blend of plastic and a specific petroleum based feedstock, which is atmospheric tower bottoms (ATBs). The process comprises mixing the ATBs petroleum based feed and plastic together, and heating the mixture above the melting point of the plastic, but not greater than 500° F. With continued mixing the plastic melt and ATBs feedstock liquid blend, the present composition and process prepares a homogeneous blend of plastic and an ATB feedstock. Optionally, the plastic melt and ATBs feedstock liquid blend may be cooled to a temperature below the melting point of the plastic.

Among other factors, the present composition and process prepares a stable blend of plastic and an ATB feedstock. This blend of plastic and ATB based feedstock provides a vehicle to efficiently and effectively feed waste plastic to refinery processes for conversion of the waste plastic to high volume products, with good yields. The present composition and process allows one to opportunistically use the ATB residue in a waste plastic recycle process in a refinery. It has been found that by preparing the present blend and feeding the blend to refinery operations such as an FCC unit, one can efficiently and effectively recycle plastic waste while also complementing the operation of a refinery in the preparation of higher value products such as gasoline, jet fuel, base oil, and diesel fuel. Polyethylene and polypropylene can also be produced from the waste plastics efficiently and effectively. In fact, positive economics are realized for the overall recycling process with product quality identical to that of virgin polymer. The use of the present blend also saves energy and is more environmentally friendly than prior recycling processes. And this is all achieved by using the residue from an atmospheric distillation tower.

### BRIEF DESCRIPTION OF THE DRAWINGS

FIG. 1 depicts the current practice of pyrolyzing waste plastics to produce fuel or wax (base case).

FIG. 2 depicts a present process of preparing a hot homogeneous liquid blend of plastic and petroleum ATBs feedstock and how the blend can be fed to a refinery conversion unit.

FIG. 3 depicts in detail the stable blend preparation process and how the stable blend can be fed to a refinery conversion unit.

FIG. 4 depicts the plastic type classification for waste plastics recycling.

FIG. 5 depicts a present process where the prepared blend is passed to a conversion FCC unit in a refinery to create value added chemicals and fuels, as well as chemicals for preparing recycled polyethylene.

FIG. 6 depicts a present process where the prepared blend is passed to a conversion unit in a refinery to create chemicals for preparing recycled polypropylene.

FIG. 7 depicts a present process where the prepared blend is passed to a conversion unit in a refinery to create chemicals.

FIG. 8 graphically shows Thermal Gravimetric Analysis (TGA) results for low density polyethylene and a polypropylene polymer.

FIG. 9 graphically depicts a thermal gravimetric analysis (TGA) of the thermal stability of four waste plastic samples.

### DETAILED DESCRIPTION

Disclosed are a novel plastic and petroleum based feedstock blend, and a process to prepare a stable blend of a plastic and an ATB residue feedstock for direct conversion of plastic in a refinery process unit.

The petroleum based feedstock comprises atmospheric tower bottoms. Atmospheric Tower Bottoms (ATBs) are the residue from an atmospheric tower distillation. The ATBs generally boil above 650° F. (343° C.). Generally, the ATBs are sent to a few different units depending on quality and demand. These units can include a Fluid Catalytic Cracking (FCC) unit or a vacuum distillation unit to recover heavy distillates for further processing into lube oils and waxes. Or, the ATBs are simply burned to recover energy. ATBs can be processed in the same refinery where they are produced, or may be optionally transported to another refinery for use. Since ATBs are a heavy petroleum fraction, they require heated equipment for pipeline transportation.

The present process involves feeding ATBs as an opportunity feedstock to a FCC unit, and optionally transporting the ATBs prior to FCC processing. Herein waste plastics are dissolved in the ATBs prior to being fed to a FCC unit where they are cracked into typical FCC products including precursors for circular plastics production. The waste plastics can be dissolved in the ATBs before or after transportation of the ATBs, or even during transit to a different facility. Since ATBs already require special equipment to transport, it is likely the plastic in an ATBs blend can be handled with existing equipment without modification. The ATBs can be transported, for example, on a heated barge, tuck, train, or a heated pipeline to another facility. The waste plastic can be mixed with the ATBs prior to transfer, or the mixing to create the blend can occur at the facility to which the ATBs is transported.

In one embodiment, provided is a process for preparing a blend of plastic, preferably waste plastic, and ATBs for storage, transportation or feeding to a refinery unit. The process comprises first selecting plastics, preferably waste plastics, containing polyethylene and/or polypropylene. These waste plastics are then passed through a blend preparation unit to make a stable blend or a homogeneous blend of waste plastic and ATBs. The blend is fed to a refinery conversion unit, such as a FCC unit or a coker unit, for direct conversion of waste plastic to value-added chemicals and fuels.

The stable blend is made by a two-step process. The first step produces a hot, homogeneous liquid blend of plastic melt and the ATBs petroleum feedstock. The preferred range of the plastic composition in the blend is about 1-20 wt. %. Generally, the amount of plastic in the blend is less than 20 wt. %, from 1 to less than 20 wt. %, and in one embodiment, the amount ranges from 1-10 wt. % based on the weight of the blend. The preferred conditions for the hot liquid blend preparation include heating of plastic above the melting point of the plastic while vigorously mixing with the ATB petroleum feedstock. The preferred process conditions include heating to a 250-500° F. temperature, a residence time of 5-240 minutes at the final heating temperature, and 0-10 psig atmospheric pressure. This can be done in the open atmosphere as well as preferably under an oxygen-free inert atmosphere.

In the second step, the hot blend is cooled down below the melting point of the plastic while continuously, vigorously mixing, and then further cooling down to a lower temperature, preferably an ambient temperature, to produce a stable blend. The stable blend is either an oily liquid or in a waxy solid state at the ambient temperature depending on the petroleum feedstock.

In one embodiment, a stable blend is made of the petroleum ATBs feedstock and 1-20 wt. % of waste plastic, wherein the plastic is in the form of finely dispersed micron-size particles with 10 micron to less than 100-microns average particle size.

There are several advantages realized by the present blend and its use. For example, the stable blend of plastic and ATBs feedstock can be stored at ambient temperature and pressure for extended time periods. During the storage, no agglomeration, no settling of polymer particles and no chemical/physical degradation of the blend are observed. This allows easier handling of the waste plastic material for storage.

Transportation of ATBs, whether part of a blend or not, will generally require heated equipment for transportation since ATBs are a heavy petroleum fraction. The blend can be handled by using the standard pumps typically used in handling ATBs. Heated equipment is needed and used to transport ATBs by barge, truck, train, or pipeline, whether the ATBs are transported either alone or in a blend. Refineries, however, are often equipped to handle ATB. During heating, no agglomeration of polymer is observed.

For feeding to a refinery unit, preferably an FCC unit or a coker unit, the stable blend is further heated at least to a temperature above the melting point of the plastic to produce a homogeneous liquid blend of ATBs and plastic. The hot homogeneous liquid blend is fed directly to the FCC refinery unit for conversion of waste plastics and the ATB to high value products with good yields.

Refinery conversion units such as a fluid catalytic cracking (FCC) unit converts the hot homogeneous liquid blend of the plastic and petroleum ATBs feedstock in the presence of catalysts with simultaneous conversion of the plastic and petroleum ATBs feedstock. The presence of catalysts in the conversion unit allows conversion of the waste plastics to higher value products at a lower operating temperature than the typical pyrolysis temperature. The yields of undesirable byproducts (offgas, tars, coke) are lower than the typical pyrolysis process. For the hydroprocessing units (hydrocracking and hydrotreating units), hydrogen can be added to the units to improve the conversion of the plastics. The blend may generate additional synergistic benefits coming from the interaction of the plastic and petroleum ATB feedstock during the conversion process. Fluid catalytic cracking and hydrocracking processes are preferred modes of catalytic conversion of the stable blend.

In one embodiment, the stable blend of plastic and petroleum feedstock can be sent to a coker unit for thermal conversion of waste plastics. In this case, there are no substantial advantages in the reactor temperature or the product yield compared to a pyrolysis process. The advantage of the coker unit is its feed flexibility in that the unit can handle a blend with very high nitrogen, sulfur, and metals impurities.

The stable blend of plastic and petroleum ATBs feedstock allows more efficient recycling of waste plastics while also providing a greater utility for ATBs. The use of the present blend is often far more energy efficient than the current pyrolysis process, and allows recycling with a lower carbon footprint. The improved processes would allow establishment of a circular economy on a much larger scale by efficiently converting waste plastics back to virgin quality polymers or value-added chemicals and fuels.

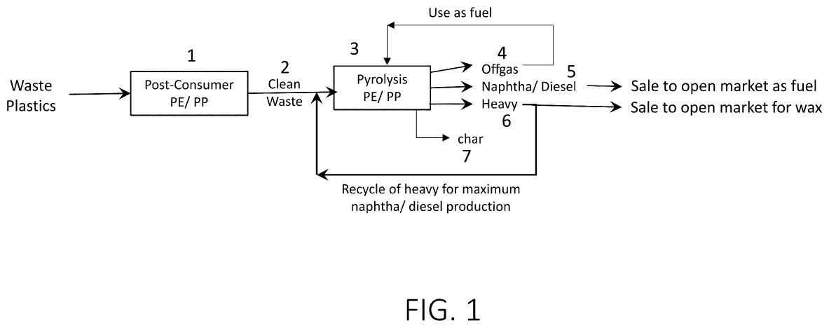

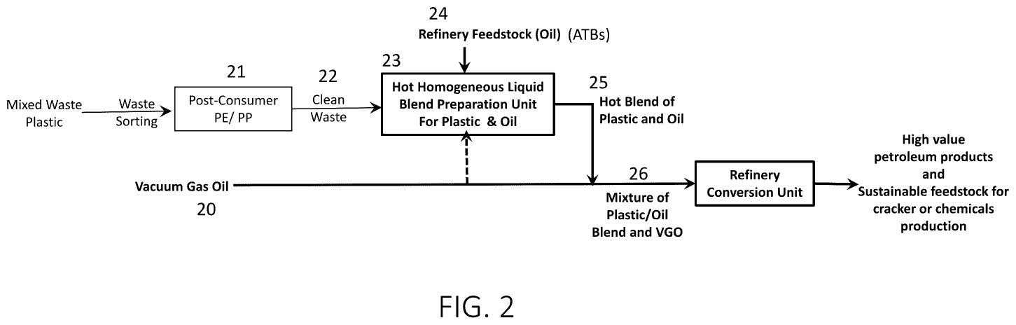

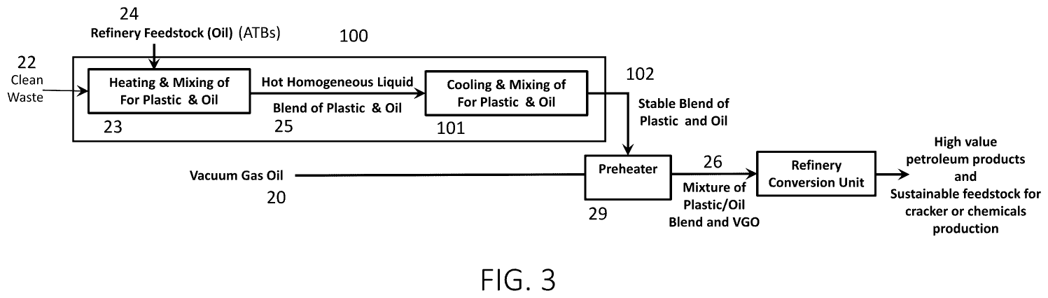

A simplified process diagram for a base case of a waste plastics pyrolysis process is shown in FIG. 1. Preparation of a hot homogeneous liquid blend of plastic and petroleum feedstock is shown in FIG. 2. FIG. 3 depicts in detail the preparation of a stable blend of waste plastic and petroleum based feedstock. The figures depict the two process steps associated with the blend preparation.

As noted above, FIG. 1 shows a diagram of the pyrolysis of waste plastics fuel or wax that is generally operated in the industry today. Generally, the waste plastics are sorted together 1. The cleaned plastic waste 2 is converted in a pyrolysis unit 3 to offgas 4 and pyrolysis oil (liquid product). The offgas 4 from the pyrolysis unit 3 is used as fuel to operate the pyrolysis unit. An on-site distillation unit separates the pyrolysis oil to produce naphtha and diesel 5 products which are sold to fuel markets, or sold as feedstocks for chemicals production. The heavy pyrolysis oil fraction 6 is recycled back to the pyrolysis unit 3 to maximize the fuel yield. Char 7 is removed from the pyrolysis unit 3. The heavy fraction 6 is rich in long chain, linear hydrocarbons, and is very waxy (i.e., forms paraffinic wax upon cooling to ambient temperature). Wax can be separated from the heavy fraction 6 and sold to the wax markets.

Use of the present blend, however, avoids the pyrolysis of the waste plastic. Rather, a blend of petroleum ATBs feedstock and the waste plastic is prepared, which can be fed to the refinery units. Thus, the pyrolysis step can be avoided, which is a significant energy savings.

The present blend can be prepared in a hot blend preparation unit where the operating temperature is above the melting point of the plastic (about 150-250° C.), to make a hot homogeneous liquid blend of plastic and ATBs. The hot homogeneous liquid blend of plastic and ATBs can be fed directly to the refinery units.

Alternatively, a blend can be prepared in a stable blend preparation unit where the hot homogeneous liquid blend is cooled to ambient temperature in a controlled manner to allow for easy storage and transportation. By using this method, a stable blend can be prepared at a facility away from a refinery and can be transported to a refinery unit. Then the stable blend is heated above the melting point of the plastic in order to feed to a refinery conversion unit. The stable blend is a physical mixture of micron-size plastic particles finely suspended in the ATB, with the average particle size of the plastic particles of 10 micron to less than 100 microns. The mixture is stable, and the plastic particles do not settle or agglomerate upon storage for extended period.

What is meant by heating the blend to a temperature above the melting point of the plastic is clear when a single plastic is used. However, if the waste plastic comprises more than one waste plastic, then the melting point of the plastic with the highest melting point is exceeded. Thus, the melting points of all plastics must be exceeded. Similarly, if the blend is cooled below the melting point of the plastic, the temperature must be cooled below the melting points of all plastics comprising the blend.

Compared with a pyrolysis unit, these blend preparation units operate at a much lower temperature (˜500-600° C. vs. 120-250° C.). Thus, employing the present blend in conjunction with a refinery can provide a far more energy efficient process than a thermal cracking process such as pyrolysis.

The use of the present waste plastic/petroleum blend further increases the overall hydrocarbon yield obtained from the waste plastic. This increase in yield is significant. The hydrocarbon yield using the present blend offers a hydrocarbon yield that can be as much as 98%. To the contrary, pyrolysis produces a significant amount of light product from the plastic waste, about 10-30 wt. %, and about 5-10 wt. % of char. These light hydrocarbons are used as fuel to operate the pyrolysis plant, as mentioned above. Thus, the liquid hydrocarbon yield from the pyrolysis plant is at most 70-80%.

When the present blend is passed into the refinery units, such as a FCC unit, only a minor amount of offgas is produced. Refinery units use catalytic cracking processes that are different from the thermal cracking process used in pyrolysis. With catalytic processes, the production of undesirable light-end byproducts such as methane and ethane is minimized. Refinery units have efficient product fractionation and are able to utilize all hydrocarbon products streams efficiently to produce high value materials. Refinery co-feeding will produce only about 2% of offgas (H₂, methane, ethane, ethylene). The C₃ and C₄ streams are captured to produce useful products such as circular polymer and/or quality fuel products. Thus, the use of the present petroleum/plastic blend offers increased hydrocarbons from the plastic waste, as well as a more energy efficient recycling process compared to a thermal process such as pyrolysis. The benefits of the present blend are significant when considering recycling waste plastic.

In some cases, the conversion of waste plastic into clean fuels takes less energy than production of fuels from a virgin petroleum feedstock. As the collection and processing of waste plastic improves the gain in energy efficiencies will further improve. Such fuels produced from a blend of waste plastic and oil will have recycle contents and lower carbon footprints than corresponding fuels made from pure petroleum feedstock. The present process can produce clean gasoline, jet fuel and diesel with recycle contents and a lower CO₂ (lower carbon) footprint from waste plastic.

FIG. 2 illustrates a method for preparing a hot homogenous blend of plastic and petroleum feedstock which can be used for direct injection to a refinery unit. The preferred range of the plastic composition in the blend is about 1-20 wt. %. Generally, the amount of plastic in the blend is less than 20 wt. %, from 1 to less than 20 wt. %, and in one embodiment, the amount ranges from 1-10 wt. % based on the weight of the blend. If high molecular weight polypropylene (average molecular weight of 250,000 or greater) waste plastic or high-density polyethylene (density above 0.93 g/cc) is used as the predominant waste plastic, e.g., at least 50 wt. %, then the amount of waste plastic used in the blend is more preferably about 1-10 wt. %. The reason being that the pour point and viscosity of the blend would be high. In one embodiment, the plastic can comprise polypropylene having an average molecular weight, Mw, in the range of 5,000 to 150,000. In another embodiment, the plastic can comprise polypropylene having an average molecular weight, Mw, in the range of 150,000 to 400,000.

The preferred conditions for the hot homogeneous liquid blend preparation include heating the plastic above the melting point of the plastic while vigorously mixing with a petroleum feedstock. The preferred process conditions include heating to a 250-500° F. temperature, with a residence time of 5-240 minutes at the final heating temperature, and 0-10 psig atmospheric pressure. This can be done in an open atmosphere as well as under an oxygen-free inert atmosphere.

The hot homogeneous blend of plastic melt and petroleum feedstock is prepared by mixing a petroleum feed and a plastic together and then heating the mixture above the melting point of the plastic, but not greater than 500° F., while thoroughly mixing. Alternatively, it is prepared by melting the plastic only and then adding the plastic melt to the warm or hot petroleum ATBs feedstock while thoroughly mixing. Alternatively, it is prepared by heating the ATBs feedstock only to the temperature above the melting point of the plastic and then adding solid plastic slowly to the hot petroleum ATBs liquid while thoroughly mixing the mixture and maintaining the temperature above the melting point of the plastic.

Referring to FIG. 2 of the Drawings, a stepwise preparation process of preparing the hot homogenous liquid blend is shown. Mixed waste plastic is sorted to create post-consumer waste plastic 21 comprising polyethylene and/or polypropylene. The waste plastic is cleaned 22 and then mixed with an oil 24 in a hot blend preparation unit 23. After the mixing in 23, the homogeneous blend of the plastic and oil is recovered 25. Optionally a filtration device may be added (not shown) to remove any undissolved plastic particles or any solid impurities present in the hot liquid blend. The hot blend of the plastic and oil can then be passed to a refinery unit. Optimally, the hot blend 25 can be combined with a refinery feedstock, such as vacuum gas oil 20, which mixture is then passed to are finery unit.

FIG. 3 illustrates a method for preparing a stable blend of plastic and oil. The stable blend is made in a stable blend preparation unit by a two-step process. The first step produces a hot, homogeneous liquid blend of plastic melt and petroleum feedstock, the step is identical to the hot blend preparation described in FIG. 2. The preferred range of the plastic composition in the blend is about 1-20 wt. %. Generally, the amount of plastic in the blend is less than 20 wt. %, from 1 to less than 20 wt. %, and in one embodiment, the amount ranges from 1-10 wt. % based on the weight of the blend. If high molecular weight polypropylene (average molecular weight of 250,000 or greater) waste plastic or high-density polyethylene (density above 0.93 g/cc) is used as the predominant waste plastic, e.g., at least 50 wt. %, then the amount of waste plastic used in the blend is more preferably about 1-10 wt. %. The reason being that the pour point and viscosity of the blend would be high.

The preferred conditions for the hot homogeneous liquid blend preparation include heating the plastic above the melting point of the plastic while vigorously mixing with a petroleum feedstock. The preferred process conditions include heating to a 250-500° F. temperature, with a residence time of 5-240 minutes at the final heating temperature, and 0-10 psig atmospheric pressure. This can be done in an open atmosphere as well as under an oxygen-free inert atmosphere.

In the second step, the hot blend is cooled down below the melting point of the plastic while continuously vigorously mixing with petroleum feedstock, and then further cooling to a lower temperature, preferably ambient temperature, to produce a stable blend of the plastic and ATBs oil.

It has been found that the stable blend is an intimate physical mixture of plastic and petroleum feedstock. The plastic is in a “de-agglomerated” state. The plastic maintains a finely dispersed state of solid particles in the petroleum feedstock at temperatures below the melting point of the plastic, and particularly at ambient temperatures. The blend is stable and allows easy storage and transportation. At a refinery, the stable blend can be heated in a preheater above the melting point of the plastic to produce a hot, homogenous liquid blend of the plastic and petroleum. The hot liquid blend can then be fed to a refinery unit as a cofeed with conventional refinery feed.

In FIG. 3, further details of the stable blend preparation are shown. The stable blend is made in a stable blend preparation unit 100 by a two-step process. As shown, clean waste 22 is passed to the stable blend preparation unit 100. The selected plastic waste 22 is heated and mixed with a refinery feedstock oil 24. The plastic waste is heated above the melting point of the plastic to melt the plastic. The petroleum feedstock is mixed with the heated plastic at 23. The mixing is often quite vigorous. The mixing and heating conditions can generally comprise heating at a temperature in the range of about 250-500° F., with a residence time of 5-240 minutes at the final heating temperature. The heating and mixing can be done in the open atmosphere or under an oxygen-free inert atmosphere. The result is a hot, homogenous liquid blend of plastic and oil 25. Optionally a filtration device may be added (not shown) to remove any undissolved plastic particles or any solid impurities present in the hot homogeneous liquid blend.

The hot blend 25 is then cooled below the melting point of the plastic while continuing the mixing of the plastic with the petroleum oil feedstock 101. Cooling generally continues, usually to an ambient temperature, to produce a stable blend of the plastic and oil 102. At a refinery, the stable blend can be fed to a preheater, 29, which heats the blend above the melting point of the plastic to produce a mixture of plastic/oil blend and, for example, VGO, 26, which is then fed to a refinery conversion unit.

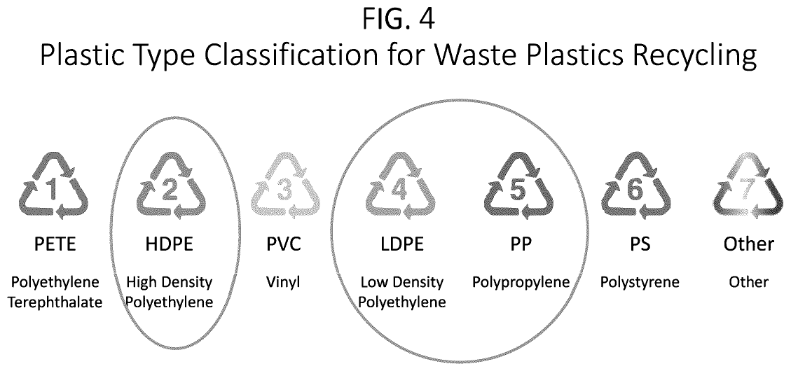

The preferred plastic starting material for use in the present blend is sorted waste plastics containing predominantly polyethylene and polypropylene (plastics recycle classification types 2, 4, and 5). The pre-sorted waste plastics are washed and shredded or pelleted to feed to a blend preparation unit. FIG. 4 depicts the plastic type classification for waste plastics recycling. Classification types 2, 4, and 5 are high density polyethylene, low density polyethylene and polypropylene, respectively. Any combination of the polyethylene and polypropylene waste plastics can be used. Polystyrene, classification 6, can also be present in a limited amount.

Proper sorting of waste plastics is very important in order to minimize contaminants such as N, Cl, and S. Plastics waste containing polyethylene terephthalate (plastics recycle classification type 1), polyvinyl chloride (plastics recycle classification type 3) and other polymers (plastics recycle classification type 7) need to be sorted out to less than 5%, preferably less than 1% and most preferably less than 0.1%. The present process can tolerate a moderate amount of polystyrene (plastics recycle classification type 6). Waste polystyrene needs to be sorted out to less than 20%, preferably less than 10% and most preferably less than 5%.

Washing of waste plastics can remove metal contaminants such as sodium, calcium, magnesium, aluminum, and non-metal contaminants coming from other waste sources. Non-metal contaminants include contaminants coming from the Periodic Table Group IV, such as silica, contaminants from Group V, such as phosphorus and nitrogen compounds, contaminants from Group VI, such as sulfur compounds, and halide contaminants from Group VII, such as fluoride, chloride, and iodide. The residual metals, non-metal contaminants, and halides need to be removed to less than 50 ppm, preferentially less than 30 ppm and most preferentially to less than 5 ppm.

The petroleum based feedstock comprises atmospheric tower buttons. Atmospheric Tower Bottoms (ATBs) are the residue from an atmospheric tower distillation. The ATBs generally boil above 650° F. (343° C.). Generally, the ATBs are sent to a few different units depending on quality and demand. These units can include a Fluid Catalytic Cracking (FCC) unit or a vacuum distillation unit to recover heavy distillates for further processing into lube oils and waxes. Or, the ATBs are simply burned to recover energy. ATBs can be processed in the same refinery where they are produced, or may be optionally transported to another refinery for use.

The present process involves feeding ATBs as an opportunity feedstock to a refinery conversion unit, preferably a FCC unit, and optionally transporting the ATBs prior to FCC processing to another refinery. Herein waste plastics are dissolved in the ATBs prior to being fed to the FCC unit where they are cracked into typical FCC products including precursors for circular plastics production. The waste plastics can be dissolved before or after transportation or even during transit at a different facility. Since ATBs already require special equipment to transport it is likely the plastic in ATB blends can be handled with existing equipment without modification.

While not wanting to be bound by a theory, the present process prepares a stable blend that is an intimate physical mixture of plastic and petroleum feedstock for catalytic conversion in refinery units. The present process produces a stable blend of petroleum feedstock and plastic wherein the plastic is in a “de-agglomerated” state. The plastic maintains its state as “finely dispersed” solid particles in the petroleum feedstock at ambient temperature. This blend is stable and allows easy storage and transportation. At a refinery, the stable blend can be preheated above the melting point of the plastic to produce a hot, homogeneous liquid blend of plastic and petroleum, and then the hot liquid blend is fed to a conversion unit. Then both the ATBs petroleum feed and plastic are simultaneously converted in the conversion unit, such as fluid catalytic cracking (FCC), coker unit, or hydrocracking (HCR) unit, with typical refinery catalysts containing zeolite(s) and other active components such as silica-alumina, alumina and clay.

The flow volume of blend to the refinery units, such as an FCC unit, can comprise any practical or accommodating volume % of the total flow to the refinery units. Generally, the flow of the blend, for practical reasons, can be up to about 50 vol. % of the total flow, i.e., the refinery flow and the blend flow. In one embodiment, the flow of the blend is an amount up to about 100 vol. % of the total flow. The volume % of the blend will also depend on the ultimate end product desired. In another embodiment, the volume flow of the blend is an amount up to about 25 vol. % of the total flow, or in one embodiment from 25 about 50 vol. %. Avoiding any negative impact on the refinery and its products is important. If the amount of the plastic in the final blend (comprising the plastic/oil blend and co-feed petroleum) is greater than 20 wt. % of the final blend, difficulties in FCC unit operation might ensue. By the final blend is meant the present plastic/ATBs blend and any co-feed petroleum. The plastic/ATBs blend can comprise up to 100 vol. % of the feed to the refinery units. Some petroleum feed, such as VGO, can suitably be cofed with the blend to the refinery units.

The present blend can be sent to refinery conversion units to provide building blocks for chemicals, fuel products such as gasoline, jet fuel, diesel fuel, and base oils. The building blocks can also be used for recycle of polyethylene and propylene.

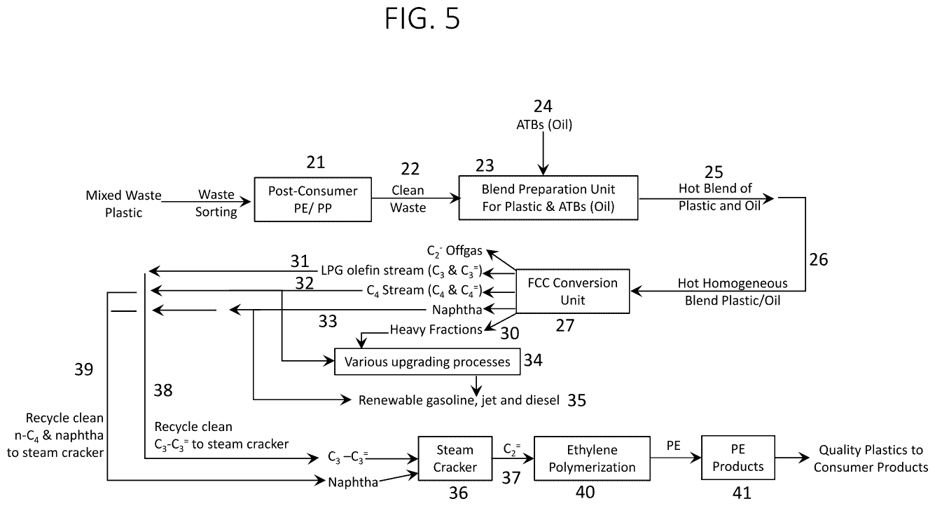

For example, in FIG. 5, cracking of the plastic/ATBs hot blend 25, either alone or combined with a co-feed petroleum feed, can be passed via 26 to a conversion FCC unit 27. The numerals in FIG. 5, which are the same as in FIGS. 2 and 3, refer to the same streams or units. The FCC unit 27 produces liquefied petroleum gas (LPG) of C₃ and C₄ olefin/paraffin streams 31 and 32, and a naphtha 33 and heavy fraction 30. The C₃ olefin/paraffin mix stream of propane and propylene mix 31 can be sent via 38 to a steam cracker 36 to produce ethylene 37. The ethylene 37 is fed to an ethylene polymerization unit 40 to produce polyethylene and ultimately polyethylene products 41.

The C₄ 32 and at least a portion of the naphtha 33 can also be sent via 39 to the steam cracker 36 to produce ethylene 37. The ethylene is fed to the ethylene polymerization unit 40 to produce polyethylene and ultimately polyethylene products 41. Other hydrocarbon product streams, such as the heavy fraction 30 from the FCC unit 27, are sent to appropriate refinery units 34 for upgrading into clean gasoline, diesel, or jet fuel. The naphtha/gasoline 33 from the FCC unit may be passed directly to a gasoline pool 35 or further upgraded before sending to a gasoline pool (not shown in the figure).

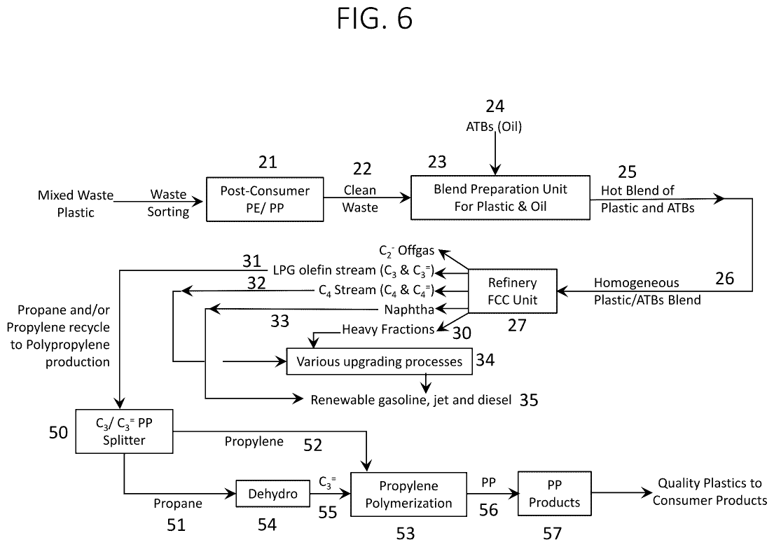

In FIG. 6, cracking of the plastic/ATBs hot blend 25, either alone or combined with a co-feed petroleum feed, can be passed via 26 to the conversion FCC unit 27. The numerals in FIG. 5, which are the same as in FIGS. 2 and 3, refer to the same streams or units. The FCC unit 27 produces liquefied petroleum gas (LPG) of C₃ and C₄ olefin/paraffin streams 31 and 32, and a naphtha 33 and heavy fraction 30. The C₃ olefin/paraffin mix stream of propane and propylene mix 31 can be sent to and separated by a propane/propylene splitter (PP splitter) 50 to produce pure steams of propane 51 and propylene 52. The propylene 52 is fed to propylene polymerization unit 52 to produce polypropylene.

The pure propane 51 may be fed to a propane dehydrogenation unit 54 to make additional propylene 55, and then ultimately polypropylene in the propylene polymerization unit 53.

Dehydrogenation of propane is practiced widely in the industry to produce propylene. The reaction is endothermic, conversion is maintained by multi-stage reactors and inter-stage heaters. The unit typically operates at high temperature (>900° F.) and low pressure (<50 psig) in the presence of noble metal (Pt) catalyst. The multi-stage process generates approximately 85% purity propylene/propane mixture. This stream is directed to a propane/propylene (PP) splitter which is a high efficiency distillation column. The splitter produces pure propylene stream with 99.5-99.8% purity.

The PP splitter unit and/or propane dehydrogenation unit can be located away from a refinery, near a refinery, or within a refinery. The propane/propylene mix is sent to the PP splitter by truck, barge, rail car or pipeline. It is preferred that the PP splitter unit and propane dehydrogenation unit are in close proximity to the refinery FCC unit.

The C₄ 32 and other hydrocarbon product streams, such as the heavy fraction 30 from the FCC unit 27, are sent to appropriate refinery units 34 for upgrading into clean gasoline, diesel, or jet fuel. The gasoline 33 from the FCC unit may be passed directly to a gasoline pool 35 or further upgraded before sending to a gasoline pool (not shown in the figure).

The polypropylene polymer 56 made in the propylene polymerization unit 53, can be made into polypropylene products 57 that will then be further incorporated into consumer products.

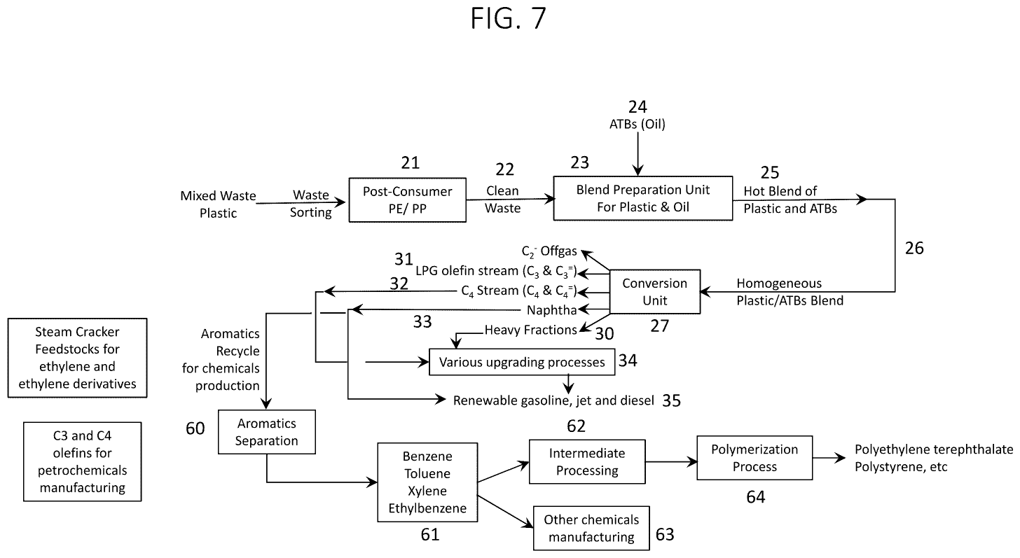

FIG. 7 shows one embodiment of a present integrated process, where the blend is sent to a fluid catalytic cracking (FCC) unit. The same numbers in FIG. 7 that correspond to FIGS. 2 and 3 refer to the same items/units. As shown, the blend is prepared 25 and then passed to the FCC conversion unit 27 via 26. The blend can be mixed with co-feed Vacuum Gas Oil (VGO) or not. The blend is generally heated to a temperature above the melting point of the plastic before passing to the FCC conversion unit 27.

In FIG. 7, cracking of the plastic/ATBs hot blend, either alone or combined with a co-feed petroleum feed, in the FCC unit 27 produces liquefied petroleum gas (LPG) of C₃ and C₄ olefin/paraffin streams 31 and 32, and a naphtha 33 and heavy fraction 30. The C₃ olefin/paraffin mix stream of propane and propylene can be sent to and separated by a propane/propylene splitter (PP splitter) to produce pure streams of propane and propylene.

The C₄ 32 and other hydrocarbon product streams, such as the heavy fraction 30 from the FCC unit 28, are sent to appropriate refinery units 34 for upgrading into clean gasoline, diesel, or jet fuel. The naphtha/gasoline 33 from the FCC unit may be passed directly to a gasoline pool 35 or further upgraded before sending to a gasoline pool (not shown in the figure).

A portion of the naphtha 33 can be passed to chemicals production. For example, the naphtha can be passed to an aromatics separation unit 60. From 60 benzene, toluene, xylene and ethylbenzene can be recovered and passed to intermediate processing 62 and/or other chemicals manufacturing 63. From the intermediate processing 62 of the chemicals, the resulting chemicals can be passed to a polymerization process unit 64. Polymers such as polyethylene terephthalate and polystyrene can be made, based on the processed chemicals recovered and sent for polymerization. For example, para-xylene would be readily used to prepare polyethylene terephthalate (PET).

The LPG and naphtha can be recovered and fed to a steam cracker for manufacturing ethylene and then ethylene derived chemicals such as polyethylene, ethylene oxides, poly alpha olefins. C₃ olefins in LPG can be recovered for manufacturing propylene and/or propylene oxides. C₄ olefins in LPG can be recovered for manufacturing low-density co-polymers (process schemes are not shown in the Figure).

In one embodiment, the conversion unit 27 is not in a refinery and only the ATBs feedstock/plastic blend is passed to the unit. Recovery of naphtha to produce aromatics would then be emphasized. The naphtha can then be transported to are finery, if desired.

The following examples are offered to illustrate certain embodiments, but are not meant to be limiting.

### Example 1: Properties of Plastic and ATBs

Properties of typical plastics that can be used for the blend preparation is shown in Table 1. The concept was demonstrated using low density polyethylene (LDPE).

TABLE 1
Properties of Plastics

| | LDPE | HDPE | PP | PP |
|---|---|---|---|---|
| | (Plastic A) | (Plastic B) | (Plastic C) | (Plastic D) |
| Form | Pellets | Pellets | Pellets | Pellets |
| Melt Index | 25 g/10 min | 12 g/10 min | — | 12 g/10 min |
| | (190° C./2.16 kg) | (190° C./2.16 kg) | | (230° C./2.16 kg) |
| Melting Point, ° C. | 116 | 125-140 | 157 | 160-165 |
| Transition Temp, ° C. | 93, softening | 125, softening | 163, softening | — |
| Density, g/mL at 25° C. | 0.925 | 0.952 | 0.9 | 0.9 |
| Hardness | — | 66 | — | 100 |
| Average molecular | — | — | ~12,000 | ~250,000 |
| weight, M_{w} | | | | |
| Average molecular | — | — | ~5,000 | ~67,000 |
| weight, Mₙ | | | | |

Simulated distillation boiling point distribution of ATBs are summarized in Table 2, and compared with vacuum gas oil (VGO). Compared with VGO, ATB has much wider boiling point distribution and much higher end point (˜1100° F. vs. 1350° F.).

TABLE 2
Simulated distillation of VGO compared to ATBs

| | Hydrotreated VGO Petroleum | ATB |
|---|---|---|
| Simdist, ° F. | Feed #1 | Feed #2 |
| IBP (0.5%) | 462 | 534 |

| | | | |
|---|---|---|---|
| 5 | wt % | 573 | 628 |
| 10 | wt % | 616 | 675 |
| 30 | wt % | 706 | 786 |
| 50 | wt % | 775 | 881 |
| 70 | wt % | 854 | 991 |
| 90 | wt % | 962 | 1176 |
| 95 | wt % | 1008 | 1280 |

| | | |
|---|---|---|
| FBP (99.5%) | 1107 | 1350 |

### Example 2: Dissolving LDPE in ATBs

A blend of plastic and ATB was prepared for FCC performance testing using the following procedure. The plastic used was low-density polyethylene (LDPE) with 0.925 g/mL of density at 25° C. The ATBs were heated to 270° F. (132° C.), then LDPE was added such that the final product was 5 wt. % LDPE. The mixture was stirred at 270° F. (132° C.) until all the LDPE dissolved.

### Example 3: ACE Testing

To study the impact of co-processing plastics and atmospheric tower bottoms (ATBs) in a refinery FCC unit, laboratory tests with a fluidized catalytic cracking (FCC) process were carried out with a homogenous blends of plastic and ATBs (Example 2) using an FCC catalyst containing USY zeolite.

Catalytic cracking experiments were carried out in an Advanced Cracking Evaluation (ACE) Model C unit fabricated by Kayser Technology Inc. (Texas, USA). The reactor employed in the ACE unit was a fixed fluidized reactor with 1.6 cm ID. Nitrogen was used as fluidization gas and introduced from both bottom and top. The top fluidization gas was used to carry the feed injected from a calibrated syringe feed pump via a three-way valve. The catalytic cracking was carried out at atmospheric pressure and a temperature of 975° F. For each experiment, a constant amount of feed was injected at the rate of 1.2 g/min for 75 seconds. The catalyst/oil ratio was varied from 4-8. After 75 seconds of feed injection, the catalyst was stripped off by nitrogen for a period of 525 seconds.

During the catalytic cracking and stripping process the liquid product was collected in a sample vial attached to a glass receiver, which was located at the end of the reactor exit and was maintained at −15° C. The gaseous products were collected in a closed stainless-steel vessel (12.6 L) prefilled with N2 at 1 atm. Gaseous products were mixed by an electrical agitator rotating at 60 rpm as soon as feed injection was completed. After stripping, the gas products were further mixed for 10 mins to ensure homogeneity. The final gas products were analyzed using a refinery gas analyzer (RGA).

After the completion of stripping process, in-situ catalyst regeneration was carried out in the presence of air at 1300° F. The regeneration flue gas passed through a catalytic converter packed with CuO pellets (LECO Inc.) to oxidize CO to CO₂. The flue gas was then analyzed by an online infrared (IR) analyzer located downstream the catalytic converter. Coke deposited during cracking process was calculated from the CO₂ concentrations measured by the IR analyzer.

A base case with only ATBs feed (Example 3-1) was compared with the blend run comprised a 5/95% blend of LDPE/ATBs (Example 3-2). The catalyst was an equilibrium catalyst removed from a commercial FCC plant. Results of the cracking experiments at 6 cat-to-oil ratio are summarized in Table 3.

TABLE 3
Catalytic cracking of ATB and LDPR/ATB Blend with ECAT

| | | Example 3-2 |
|---|---|---|
| | Example 3-1 | Plastic/ATBs |
| Example | Base Case | Blend, Invention |
| Feed | ATBs Only | ATBs + 5% LDPE |
| Conversion, wt %* | 87.67 | 88.51 |
| Temperature (F.) | 975 | 975 |
| Cat/Oil, wt/wt | 6 | 6 |
| FCC Yields, wt % | | |
| Coke | 5.60 | 6.19 |
| Dry Gas, total | 2.07 | 2.15 |
| Hydrogen | 0.09 | 0.10 |
| Methane | 0.70 | 0.73 |
| Ethane | 0.46 | 0.48 |
| Ethylene | 0.77 | 0.81 |
| LPG, total | 25.71 | 26.66 |
| Propane | 1.95 | 2.01 |
| Propylene | 6.74 | 7.04 |
| n-Butane | 1.79 | 1.84 |
| Isobutane | 7.70 | 7.95 |
| C4 Olefins | 7.53 | 7.82 |
| Standard cut gasoline (C5 - 430 F.) | 54.29 | 53.51 |
| LCO (430-650 F.) | 8.31 | 7.78 |
| HCO (650 F.+) | 4.03 | 3.71 |
| Gasoline Composition, wt % | | |
| Gasoline nParaffins | 3.19 | 3.27 |
| Gasoline Iso-paraffins | 28.19 | 28.32 |
| Gasoline aromatics | 48.65 | 48.98 |
| Gasoline naphthenes | 6.77 | 6.40 |
| Gasoline olefins | 13.08 | 12.92 |
| Aromatics Yields, wt % | | |
| Benzene | 0.65 | 0.00 |
| Toluene | 6.08 | 6.12 |
| Ethylbenzene | 1.51 | 1.52 |
| m-xylene | 6.74 | 6.81 |
| p-xylene | 2.32 | 2.35 |
| o-xylene | 3.07 | 3.14 |
| Total xylenes | 12.12 | 12.31 |
| % of p-xylene to total xylenes | 19% | 19% |
| Aromatics, wt % of feed | 26.41 | 26.21 |
| LPG Composition | | |
| C3=/C3 | 78% | 78% |
| C4=/C4 | 44% | 44% |
| C4=/C3= | 1.12 | 1.11 |
| Gasoline Octane Numbers** | | |
| RON-GC | 92.26 | 92.10 |
| MON-GC | 81.43 | 81.31 |
| (R + M)/2 | 86.85 | 86.71 |

*Conversion—conversion of 430° F.⁺ fraction to 430° F.⁻
**Octane number, (R + M)/2, was estimated from detailed hydrocarbon GC of FCC gasoline.

The results in Table 3 show that 5 wt. % cofeeding of plastic only makes very slight changes for the FCC unit performance indicating co-processing of plastic up to 5 wt. % is readily feasible. We expect up to 20% could be run without any performance issues, but appropriate equipment with good control is needed to handle the increased viscosity and pour point.

The plastic cracked more easily than ATB, thus the conversion increased slightly for the blends. The plastic added to the FCC feed led to very slight increases of coke and dry gas yields, but the changes are small that can be managed by adjusting the conversion and operating conditions. A moderate increase in LPG was observed while slight decreases in LCO and HCO yields were observed. The gasoline yield is similar. With paraffinic nature of cracked products made from the plastic, we expected the blends with plastic may lower the octane number slightly. With the 5 wt. % plastic blending, the octane number loss was within experimental error. With refinery operational flexibility, such octane number debits can be easily compensated with blending, or by adjusting FCC process operations and catalyst/additive formulations. The hydrocarbon compositions of all the cofeeding products are well within the typical FCC gasoline range.

### Example 4: Properties of Waste Plastic Samples

Four waste plastic samples were purchased and their properties are summarized in Table 4. FT-IR was used to identify the general nature of the plastic. In addition to identification of the predominant polymer species, the FT-IR data also revealed that all these recycled plastic contained varying amounts of calcium carbonates and talc. To estimate the amount of potentially recoverable hydrocarbon, each sample was calcined under N₂ at 1000° F. for 3 hours. It was assumed that the recoverable hydrocarbon equals the % loss-on-ignition (LOI). The inorganic residue from the calcination was analyzed with ICP analysis. Using the LOI value and ICP analysis, wt. % impurity in the as-received plastic was estimated and reported in Table 4 below. The most common impurities in waste plastic are Ca, Mg, Si and Ti that may come from plastic consumer product manufacturing as calcium carbonate, silica, and talc, which are commonly used filler material. Al, Fe, P, Zn are also present in substantial quantities.

TABLE 4
Properties of Waste Plastics

| | Waste Plastic#1 | Waste Plastic #2 | Waste Plastic #3 | Waste Plastic #4 |
|---|---|---|---|---|
| | (Plastic E) | (Plastic F) | (Plastic G) | (Plastic H) |
| Form | Pellets | Pellets | Pellets | Pellets |
| General Identification | PP, PE Mix | Polypropylene | PE, PP mix | PP, PE mix |
| LOI, wt % | 93.35 | 99.38 | 96.86 | 98.1 |
| Impurities, wt % | | | | |
| Al, wt % | 0.15 | — | 0.03 | 0.05 |
| Ca, wt % | 1.41 | — | 0.51 | 0.49 |
| Fe, wt % | 0.06 | — | 0.01 | 0.11 |
| Mg, wt % | 0.34 | — | 0.02 | 0.04 |
| P, wt % | 0.01 | — | 0 | 0 |
| Si, wt % | 0.82 | — | 0.06 | 0.12 |
| Ti, wt % | 0.24 | — | 1.0 | 0.52 |
| Zn, wt % | 0.01 | — | 0.01 | 0.01 |

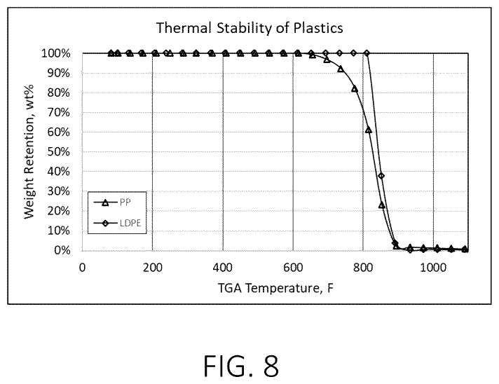

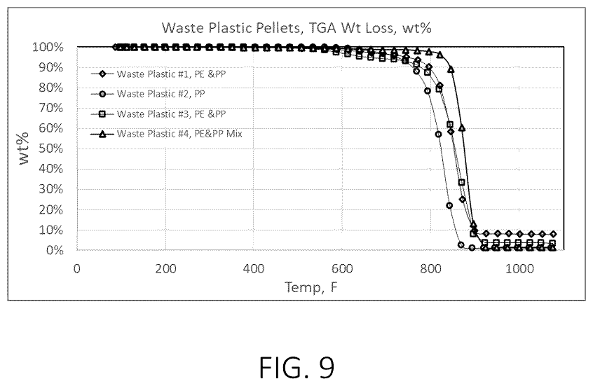

Thermal Gravimetric Analysis (TGA) was conducted with the waste plastic samples to verify the plastic materials are thermally stable well above the melt preparation temperature. TGA results shown in FIG. 8 and FIG. 9 indicate the waste plastic samples are stable up to 700° F.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise that as specifically described without actually departing from the spirit and scope of the present invention as defined by the appended claims.

What is claimed is:

1. A blend of a petroleum atmospheric tower bottoms (ATBs) feedstock and 1-20 wt. % of plastic, based on the weight of the blend, with the plastic comprising polyethylene and/or polypropylene, and the plastic in the blend comprising finely dispersed micron-size particles having an average particle size of 10 micron to less than 100 microns.

2. The blend of claim 1, wherein the amount of plastic in the blend comprises from 1 to less than 20 wt. % of the blend.

3. The blend of claim 1, wherein the plastic comprises low density polyethylene.

4. The blend of claim 1, wherein the plastic comprises high density polyethylene.

5. The blend of claim 4, wherein the blend comprises from 1-10 wt. % of the high density polyethylene.

6. The blend of claim 1, wherein the plastic comprises polypropylene having an average molecular weight, Mw, in the range of 5,000 to 150,000.

7. The blend of claim 1, wherein the plastic comprises polypropylene having an average molecular weight, Mw, in the range of 150,000 to 400,000.

8. The blend of claim 7, wherein the blend comprises from 1-10 wt. % of the polypropylene.

9. The blend of claim 1, wherein the plastic comprises a mixture of polyethylene and polypropylene.

10. The blend of claim 1, wherein the plastic is a waste plastic mixture comprising polyethylene and polypropylene.

11. The blend of claim 1, wherein the finely dispersed particles have an average particle size in the range of 10-50 microns.

12. The blend of claim 1, wherein the finely dispersed particles have an average particle size in the range of 10 to less than 100 microns.

13. The blend of claim 1, wherein the blend further comprises vacuum gas oil.

14. The blend of claim 1, wherein the blend is at a temperature above the melting point of the plastic and is a hot, homogenous liquid blend.

15. A process for preparing the blend of plastic and petroleum of claim 1, comprising:
(a) mixing a petroleum ATBs feedstock and a plastic comprising polyethylene and/or polypropylene together and heating the mixture above the melting point of the plastic, but less than 500° F., while mixing; and
(b) cooling the plastic melt and petroleum feedstock liquid blend to a temperature below the melting point of the plastic.

16. The process of claim 15, wherein the cooling in (b) is conducted together with continuous stirring.

17. The process of claim 15, wherein the heating is conducted at a temperature of 250-450° F. with a residence time of 5-240 minutes at a final heating temperature.

18. The process of claim 16, wherein the cooling is continued until ambient temperature is reached.

19. The process of claim 15, wherein the plastic is a waste plastic mixture comprises polyethylene and polypropylene.

20. A process for converting waste plastic into recycle for polyethylene polymerization comprising:
(a) selecting waste plastics comprising polyethylene and/or polypropylene;
(b) preparing a blend of a ATBs feedstock and the selected waste plastic with the blend comprising about 20 wt. % or less of the selected waste plastic;
(c) passing the blend at a temperature above the melting point of the waste plastic in the blend to a FCC unit;
(d) recovering a C₃ olefin/paraffin mixture from the FCC unit; and
(e) passing the C₃ mixture to a steam cracker to make ethylene.

21. The process of claim 20, wherein the volume flow of the blend to the FCC unit in (c) comprises up to 100 vol. % of the total hydrocarbon flow to the FCC unit.

22. The process of claim 20, wherein the volume flow of the blend to the FCC unit in (c) comprises up to 50 vol. % of the total hydrocarbon flow to the FCC unit.

23. A process for converting waste plastic into recycle for polypropylene polymerization comprising:
(a) selecting waste plastics comprising polyethylene and/or polypropylene;
(b) preparing a blend of a ATBs feedstock and the selected waste plastic with the blend comprising about 20 wt. % or less of the selected waste plastic;
(c) passing the blend at a temperature above the melting point of the plastic to a FCC unit;
(d) recovering a C₃ olefin/paraffin mixture from the FCC unit;
(e) separating the C₃ paraffin and C₃ olefin into different fractions; and
(f) passing the C₃ olefin to a propylene polymerization reactor.

24. The process of claim 23, wherein the volume flow of the blend to the FCC unit in (c) comprises up to 100 vol. % of the total hydrocarbon flow to the FCC unit.

25. The process of claim 23, wherein the volume flow of the blend to the FCC unit in (c) comprises up to 50 vol. % of the total hydrocarbon flow to the FCC unit.

26. A continuous process for converting waste plastic into aromatics and chemical monomers comprising:
(a) selecting waste plastics comprising polyethylene and/or polypropylene;
(b) preparing a blend of a ATBs feedstock and the selected waste plastic with the blend comprising about 20 wt. % or less of the selected waste plastic;
(c) passing the blend at a temperature above the melting point of the waste plastic in the blend to a FCC unit;
(d) recovering a naphtha mixture from the FCC unit; and
(e) passing the naphtha mixture to an aromatics separation unit.

27. The process of claim 26, wherein benzene, toluene, xylenes, ethylbenzene, or a mixture thereof is recovered from the aromatics separation unit.
